(19) United States
(12) Patent Application Publication
(10) Pub. No.: US 2017/0278412 A1
(43) Pub. Date: Sep. 28, 2017

(54) MOTIVATIONAL GAMIFICATION ENGINE SYSTEM AND METHOD

(71) Applicant: Kids Financial Drivers Inc., Burnaby (CA)

(72) Inventors: Melissa Sue Ella MARIN, Vancouver (CA); Yasantha Amal INDIGAHAWELA, Burnaby (CA)

(21) Appl. No.: 15/469,181

(22) Filed: Mar. 24, 2017

Related U.S. Application Data
(60) Provisional application No. 62/313,667, filed on Mar. 25, 2016.

(51) Int. Cl. G09B 5/02; A63F 13/85; A63F 13/65; G06Q 10/06; A63F 13/46

(52) U.S. Cl. CPC G09B 5/02; G06Q 10/06398; A63F 13/46; A63F 13/65; A63F 13/85

(57) ABSTRACT

Provided herein are systems and methods for providing a motivational gamification engine.

This application claims the benefit of U.S. Provisional Application No. 62/313,667, filed Mar. 25, 2016.

### FIELD

The present disclosure relates to computers, and more particularly, to systems and methods for providing a motivational game on computing devices.

### BACKGROUND

Homes, schools, workplaces and multiple organizations where there are teams, and the like all share the same common problem in finding effective ways to motivate individuals and teams to be more productive in real life situations. The foundation of why people and teams everywhere are facing motivational issues is caused by the fact that the design in current systems alike are built in such ways that people see tasks, chores or jobs. What's wrong with these people motivation systems is that tasks, chores or jobs makes people feel that what they are doing is work. There is no game environment created but points and game like rewards are given for doing work. Work, task, chores and like does not transform to game environment in current systems, which is the main cause of the failure of current systems.

In today's modern world children are more motivated to play online games and parents are finding it harder and harder to find effective ways to motivate their children to be productive at home. The methods that are available today for parents to motivate children at home are comprised of chore lists, star charts, allowances and online applications. Funifi, SuperKids and Monsta Chores are a few of many child friendly motivational applications available in the market today. The problem with these applications is that the reward methods used for collecting points or stars for completing a task is not sufficient in motivating children over longer periods of time. Other issues of this problem with child friendly motivational applications arises from lack of collaboration in ways that none of the available applications support parent participation in the application towards working with the child. The current motivational applications also lack the need for children to feel like what they are doing is fun and do not instantly reward the children to promote in furthering good behavior. Another problem with child friendly motivational applications is they are set up to look like jobs, chores and individualize the child user to work on their own without team support or group guidance. All these application gives points and game like rewards to tasks, chores and like but fail to create game environment.

School teachers like parents also share the same problem of finding effective ways to motivate children. Some teachers are becoming familiar with the term Game and few are using motivational software such as GradeCraft, Classcraft, 3D GameLab and the like. GradeCraft provides points and badges for completing course milestones. GradeCraft has the common failing point of work to points without transforming work to game environment. GradeCraft focuses individual students and not the team or parent collaboration. Classcraft has the teams but Classcraft has the same problem of work to points without transforming work to game environment. For each activity Classcraft gives positive or negative points depending on the activity. Classcraft points are arbitrary. Classcraft also has common problem of considering points as competition without work being transform to a game. 3D GameLab giving point to activities. 3D GameLab also has common problem of failing to transform real life activities to a game environment to motivate students.

Similar to families Corporations and workplaces also have problems motivating individual employees as well as company teams. Corporations use performance metrics for individuals. The problems with performance metrics are they put extra pressure on employees, they're measured subjectively and individuals are compared to other employees, which leaves some employees feeling less valuable to the company. Also rewards for performance metrics are delayed in most cases towards year-end.

Tracking performance metrics does not necessarily create motivation for these reasons and the like.

### BRIEF DESCRIPTION OF DRAWINGS

FIGS. 1 illustrates Motivational Gamification Engine Network Diagram showing an example environment where the Motivational Gamification Engine could be implemented.

FIG. 2 illustrates Motivational Gamification Engine Data Flow Diagram showing what kind of information will be input to and output from the Motivational Gamification Engine Server, where the data will come from and go to, how data processed and where the data will be stored.

FIG. 3 illustrates Motivational Gamification Engine Interaction Diagram showing an example set of messages communicated between components together with their sequence when Player Devise 120 updates an activity status which are relate to a simulated race competition.

FIG. 4 illustrates Motivational Gamification Engine Interaction Diagram for SpeedPoints showing an example set of messages communicated between components together with their sequence when player updates a SpeedPoints activity.

FIG. 5 illustrates Motivational Gamification Engine Activity Normalization diagram.

FIG. 6 illustrates the Behavioral Base Points Score Calculation and Team Ranking Algorithm.

FIG. 7 illustrates different types of point scale graphs that Motivational Gamification Engine Server could use to score teams.

FIG. 8 illustrates Motivational Gamification Engine Network Diagram showing how devices apply to Family.

FIG. 9 illustrates Motivational Gamification Engine Data Flow Diagram Applying to Family shows how data flows from Family devices to Motivational Gamification Engine Server and how the data is processed and presented back to Family Devices.

FIG. 10 illustrates Motivational Gamification Engine Network Diagram applying to Company shows how the devices are applied to Admin Device or Team Leader Device where team leader and the like is the administrator.

FIG. 11 illustrates Motivational Gamification Engine Data Flow Diagram Applying to Company shows how data flows from company Game Engine Client Devices to Motivational Gamification Engine Server and how the data is processed and presented back to company Game Engine Client Devices.

FIG. 12 illustrates Motivational Gamification Engine Server.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file servers, computer servers, and/or memory storage devices. Each of these conventional distributed computing components is accessible by the processor via a communication network.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

Motivational Gamification Engine is a system that uses simulated competitive game environment comprise of real life activities normalized for fairness to better promote people motivation in real life situations with behavior base score points scale graphs.

In one example Motivational Gamification Engine motivate families by simulating a Horse race. How well children and parents do in the race is determined by how well family collaborate to achieve family responsibilities as a team and which is scored according to a point scale graph suitable for family motivation. Every activity is updated real time making the race interesting with real time movements. Families could compete with other families in the family circle creating a simulated race to motivate children and parents.

Motivational Gamification Engine motivates teams and individual by using motivating factors that comprise of competition, collaboration between team members, recognition for teams and as individuals, achievements for all, value in work for each team member and also provides sense of responsibility for all team members and the like.

Motivational Gamification Engine has adjustable point scale graphs for scores to emphasize different type of motivational behavior. In the family example, point scale score graphs are adjusted to show close competition between families without showing clear winners or losers. In company example point scale score graphs can be adjusted to emphasize exaggerated differences between teams to motivate high performance. Motivational Gamification Engine's point scale graphs could be set up for different groups motivating different behaviors based on how the operator wants groups to perform.

The Motivational Gamification Engine normalizes activities performed by multiple groups in a fair way that translates into a competitive environment in a real time fashion. Motivational Gamification Engine comprises of rules, calculations, and point scale score graphs that could be adjusted. Teams of different sizes, ages, experience and responsibilities can compete in a fair and fun way testing their abilities to complete their individual activities as a group or an individual. Motivational competition reports are generated at group level as well as at the individual level.

Motivational Gamification Engine also comprises of individual motivation systems in addition to group-to-group motivational system. One of the features of an individual motivation within the Motivational Gamification Engine is SpeedPoints.

SpeedPoints reward and further motivate personal achievements of urgent activities or responsibilities, which are above the regular responsibilities.

Motivational Gamification Engine also comprise of social component motivating and supporting interactions amongst teams and team members.

Motivational Gamification Engine brings together work and play to motivate teams and individuals to do real life responsibilities and the like.

Example Environment Where Motivational Gamification Engine Could Be Implemented

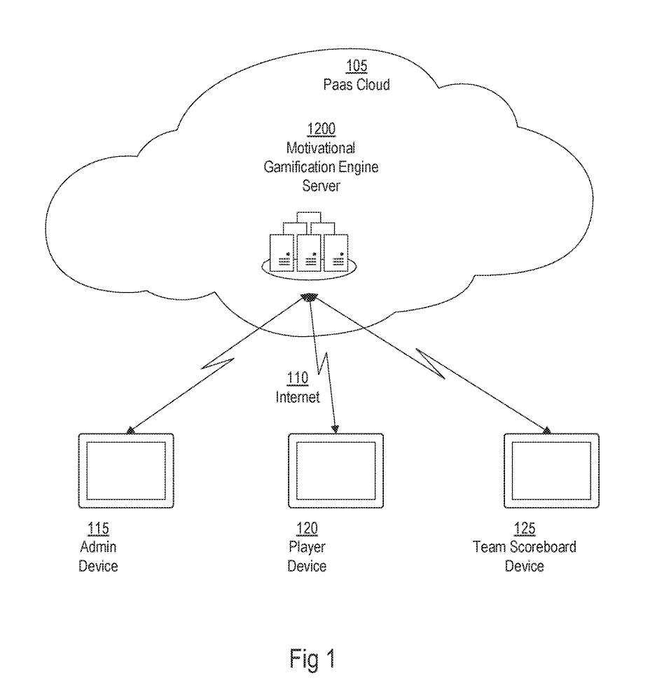

FIG. 1: Motivational Gamification Engine Network Diagram shows an example environment where the Motivational Gamification Engine could be implemented.

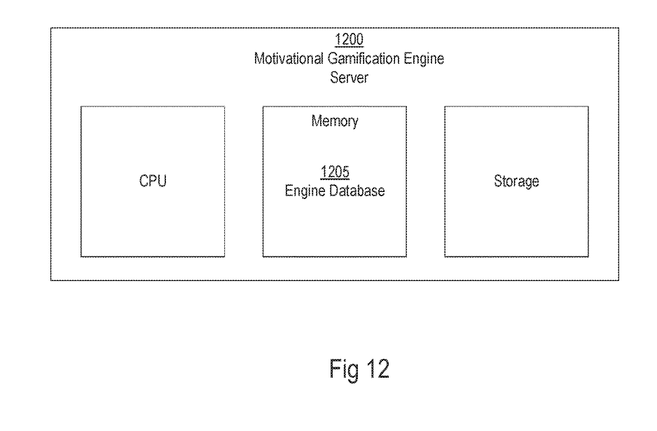

Motivational Gamification Engine Server 1200 (as show in FIG. 12) could be hosted on Platform as a service (Paas) Cloud environment that is shown as Paas Cloud 105. Examples of such Paas Clouds 105 are Amazon AWS, Microsoft Azure, Google Cloud Platform, Heroku and the like. Motivational Gamification Engine Server 1200 which is based on Server comprise of algorithms and the like and Engine Database 1205 which stores the team data, activities, rules and point scales and the like. Engine Database 1205 could be hosted remotely from Game Engine Server 1200 as well.

Teams use Motivational Gamification Engine client devices such as Player Device 120, Admin Device 115, Team Scoreboard Device 125 and the like. Motivational Gamification Engine client devices could connect to Motivational Gamification Engine Server 1200 over the Internet 110 or suitable network.

Players in the team could use Player Device 120. Player Device 120 could be a laptop, desktop, tablet, smartphone, game console, smart watch and the like. Admin Device 115 could use by Administrators in the team. Admin Device 115 could be a laptop, desktop, tablet, smartphone, game console and the like. Teams could use team Scoreboard Device 125. Team Scoreboard Device 125 could be tablet, smart TV, LCD Media player and the like.

How Motivational Gamification Engine receives data, processes, stores and represented back

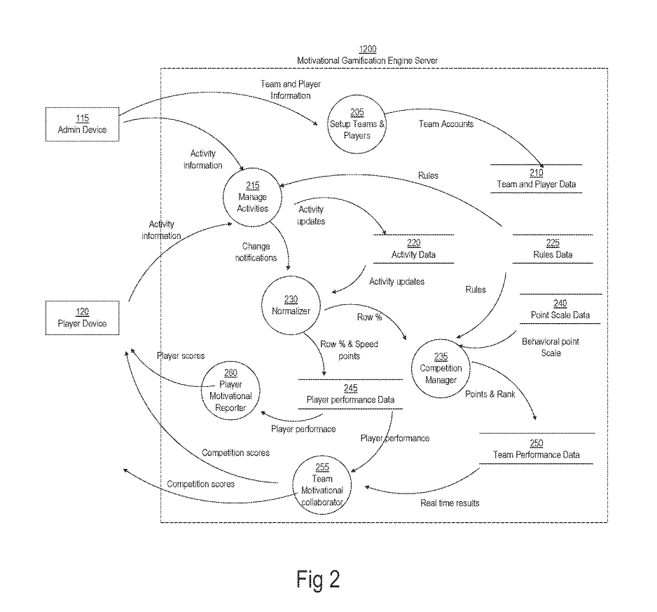

FIG. 2: Motivational Gamification Engine Data Flow Diagram shows what kind of information will be input to and output from the Motivational Gamification Engine Server 1200, where the data will come from and go to, how data processed and where the data will be stored.

Motivational Gamification Engine Server 1200 comprise of following processes

Setup Teams & Players 205 Process:

Setup Teams & Players 205 process receives team and player information from Admin Device 115. Team information comprise of Team name, Team avatar and the like. Player information comprised of player's name, nickname, gender, age and the like. Setup Teams & Players 205 process create team accounts and store in Team and Player Data 210 in Engine Database 1205.

Manage Activities 215 Process:

Manage Activities 215 process receives activity information from Admin Device 115. Activity information from Admin Device 115 comprise of information such as competition (race), number of session for a competition, activity details for each team member related to the competition and the like. Each team member's activity list comprises an activity name, activity schedule, activity belong to which session of the competition, level of complexity for team member and like. Manage Activities 215 refer to rules from Rules Data 225 store any apply rules when Manage Activities 215 process the activity information. Example rule could be minimum and maximum number of activities required to enter to a competition for a player. Manage Activities 215 process stores activity information in Activity Data 220 in Engine Database 1205.

Manage Activities 215 process also receives activity information from Player Device 120. Activity information from Player Device 120 comprise of updates of activity status from the player, activity list updates and the like. Manage Activities 215 process activity updates from Player Device 120 and update the Activity Data 220 store. Manage Activities 215 process notify the activity status updates to the Normalizer 230 after completing the processing.

Normalizer 230 Process

Normalizer 230 process receives activity status updated from Manage Activities 215. Normalizer 230 reads the activity information from Activity Data 220 store and performs Activity Normalization Algorithm 500. After completing the Activity Normalization Algorithm 500, Normalizer 230 updates the Row % & Speed points of the individual player in Player Performance Data 245 store in Engine Database 1205.

Normalizer 230 notify Row % for each Team to Competition Manager 235.

Competition Manager 235 Process

Competition Manager 235 process receives Row % for each Team from Normalizer 230. Competition Manager 235 retrieve rules from Rules Data 225 store and motivational behavioral point scale score graphs from Point Scale Data 240 store.

Competition Manager 235 then performs Behavioral Base Points Score Calculation and Team Ranking Algorithm 600. After completing Behavioral Base Points Score Calculation and Team Ranking Algorithm 600, Competition Manager 235 update team point scores and rank in Team Performance Data 250 in Engine Database 1205.

Player Motivational Reporter 260 Process

Player Motivational Reporter 260 process receives player performance information from Player Performance Data 245 store. Player Motivational Reporter 260 sends player information to Player Device 120 as motivational formats appropriate to the user of the Player Device 120. These motivational formats include SpeedPoints, player scores, Performance history, improvement suggestions and the like.

Team Motivational Collaborator 255 Process

Team Motivational Collaborator 255 process receives real time results of team competition data from Team Performance Data 250 store. Team Motivational Collaborator also receives real time results of Player performance data from Player Performance Data 245 store. Team Motivational Collaborator 255 process player and team results and send competition scores to Player Device 120 and Team Scoreboard Device 125 as motivational information formats appropriate to the users of the Player Device 120 and user community of the Team Scoreboard Device 125. Team Motivational Collaborator 255 also supports team-to-team, player-to-player and the like interactions creating a motivational social environment.

Communication behavior of Motivational Gamification Engine components by means of message interchange

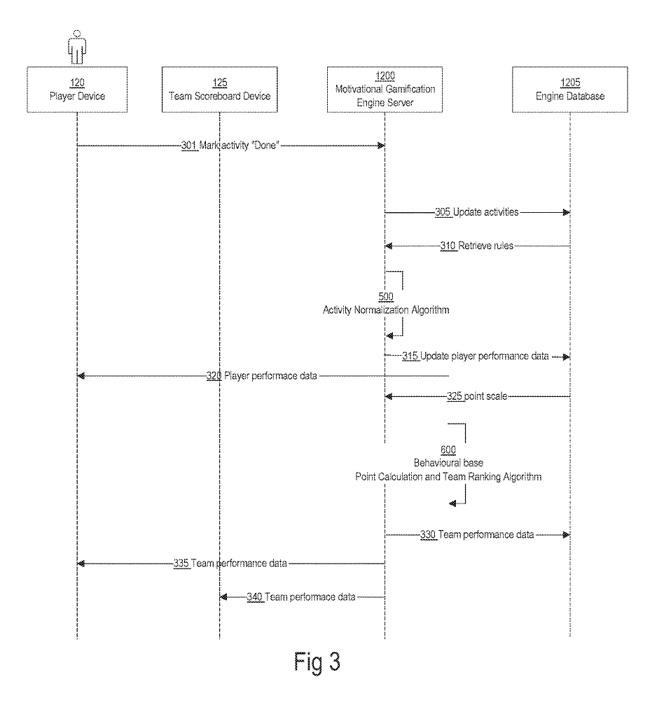

FIG. 3: Motivational Gamification Engine Interaction Diagram shows an example set of messages communicated between components together with their sequence when Player Devise 120 updates an activity status which are relate to a simulated race competition.

Player Device 120 sends Mark activity “Done” 301 messages to Motivational Gamification Engine Server 1200 when player completes an activity which are recorded for the session of the competition.

Then Game Engine Server 1200 update activity in the Activity Data 220 in Engine Database 1205 via Update activities 305 message.

Game Engine Server 1200 requires rules to process the activity received. Game Engine Server 1200 uses Retrieve rules 310 message to retrieve rules from Engine Database 1205.

Game Engine Server 1200 performs Activity Normalization Algorithm

500. Results from Normalization Algorithm 500 updated in Engine Database 1205 with Update player performance data 315 message. Then Game Engine Server 1200 send Player performance data 320 message to Player Device 120.

Game Engine Server 1200 requires Point Scales for Different Motivational Behaviors 700 data from Engine Database 1205. Game Engine Server 1200 retrieves point scale for scoring using point scale 325.

Then Game Engine Server 1200 performs 600 Behavioral base Points Score Calculation and Team Ranking Algorithm 600, which gives team performance data for the competition.

After Game Engine Server 1200 completing processing of team performance scores, Motivational Gamification Engine Server 1200 send Team scores to player device 120 using Team performance data 335 message and to Team Scoreboard Device 125 using Team performance data 340 message. This is how real time updates of the competition received by Game Engine client devices during for update of an activity. Team's rank, points and position in the race are updated real time with each and every activity update.

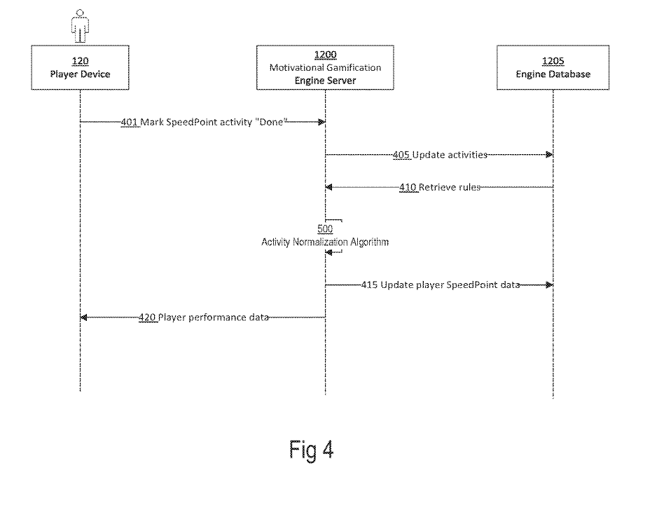

FIG. 4: Motivational Gamification Engine Interaction Diagram for SpeedPoints shows an example set of messages communicated between components together with their sequence when player updates a SpeedPoints activity. SpeedPoints are the individual motivation system with activities relating to urgent or extraordinary activities that motivate players individually. Performing these activities does not impact the team competition but individual player can earn SpeedPoints.

When player completes SpeedPoints activity, Player Device 120 sends Mark SpeedPoint activity “Done” 401 message to Motivational Gamification Engine Server 1200.

Then Game Engine Server 1200 update activity in the Activity Data 220 in Engine Database 1205 via Update activities 405 message. Game Engine Server 1200 requires rules to process the SpeedPoint activity received. Game Engine Server 1200 uses Retrieve rules 410 message to retrieve rules from Engine Database 1205.

Then Game Engine Server 1200 performs Activity Normalization 500 Algorithm which also calculated the individual SpeedPoints. Game Engine Server 1200 calculates SpeedPoints and update Engine Database 1205 with Update player SpeedPoint data 415 message. After that Game Engine Server 1200 send Player performance data 420 messages to Player Device 120 with updated SpeedPoint information.

How the calculations work: Activity Normalization Algorithm500

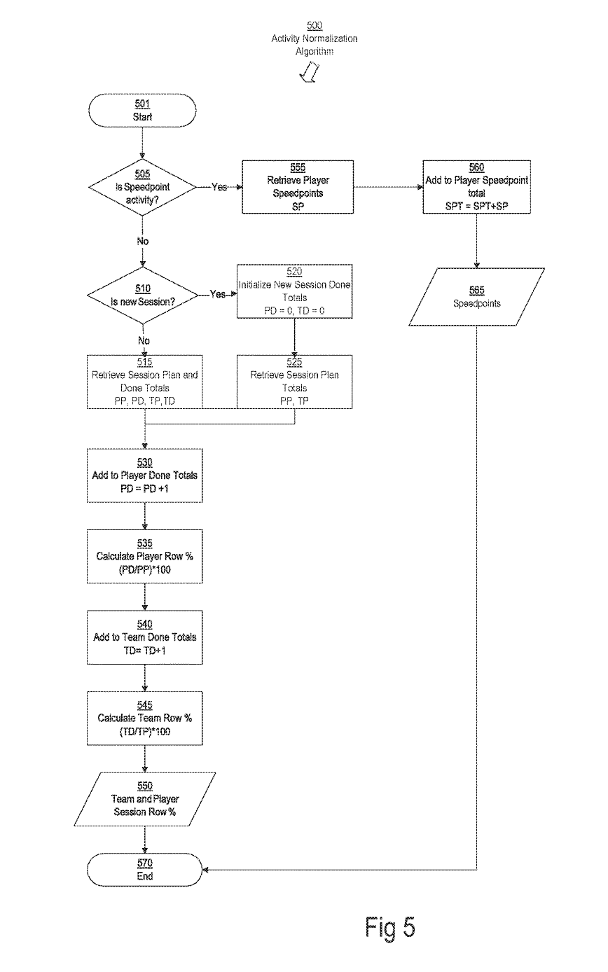

FIG. 5: Motivational Gamification Engine Activity Normalization shows the Activity Normalization Algorithm 500

In block 501 Algorithm starts. Block 501 get triggered upon Player Device 120 sends a message with activity as completed to Motivational Gamification Engine Server 1200. Completed activity is referred to as done activity in Algorithm. When Normalizer 230 process gets notified with done activity, Algorithm starts with block 501 and goes to conditional block 505.

In conditional block 505, Algorithm evaluate whether current done activity is type SpeedPoint activity (Individual motivation points) or regular activity relate to team play. If the done activity is not a SpeedPoint activity, Algorithm follows block 510 path. If done activity is a SpeedPoint activity, Algorithm follows the path with block 555.

In block 510 path for activity relate to competition, Algorithm evaluate whether current session is a new session in the competition. If current session is a new session, Algorithm goes to block 520, which does the initialization for new session total variables.

PD=0 (Player Done Activity Count)

TD=0 (Team Done Activity Count)

After Algorithm initialize session variables for the new session, routing goes to block 525 which retrieve the plan totals of the player and plan totals for player's team from Engine Database 1205

PP=Player Planned Activity Count

TP=Team Planned Activity Count

Algorithm completes initialization of variables for new session with above described 520 and 525 blocks.

If the session is an existing session in the competition or after completing block 525, Algorithm goes to block 515. In block 515, Algorithm retrieve the plan and done totals of the player and player's team from Engine Database 1205

PP=Player Planned Activity Count

PD=Player Done Activity Count

TP=Team Planned Activity Count

TD=Team Done Activity Count

Next Algorithm execute block 530. Block 530 involves adding to player done totals. Increase player done totals by one to reflect the current done activity for the session

PD=PD+1

Activity may have hard, medium or easy levels with different counts such as 1, 2 and 3. Rules being applied how to normalize. In this example, only 1 is counted considering level is how the player feels. In another example it could follow other normalization techniques.

Next Algorithm execute block 535. Now Algorithm has both player's planned activity count (PT) and player's current done activity count (PD). With PT and PD, Algorithm calculates players Row % completion for the session.

Player Row %=(PD/PP)*100

Next Algorithm execute block 540. Block 540 involves calculating team activity count totals. Increase team done activity count (TD) by one to reflect the current done activity for the session

TD=TD+1

Next Algorithm execute block 545. Now Algorithm has both Team's Planned Activity Count (TP) and Team's Done Activity Count (TD). With TP and TD, Algorithm calculates Team's Row % completion for the session.

Team Row %=(TD/TP)*100

Next in block 550 Algorithm stores Player Row % and Team Row % in Engine Database 1205.

Now let's look at the block 555 path which involves SpeedPoints. In block 555 retrieve the player SpeedPoints Total from Engine Database 1205.

Now Algorithm has following two variables with data.

SPT (Player SpeedPoints Total)

SP (Player SpeedPoints for current done activity)

Next Algorithm execute block 560. In block 560 Player's SpeedPoint total calculated

SPT=SPT+SP

Next in block 565 Algorithm stores the SpeedPoint total in Engine Database 1205

Next comes to the end of the Algorithm block 570. In this block Algorithm notify Competition Manager 235 with Team Row % for the session and end the Algorithm.

How the calculations work: Behavioral base Points Score Calculation and Team Ranking Algorithm 600

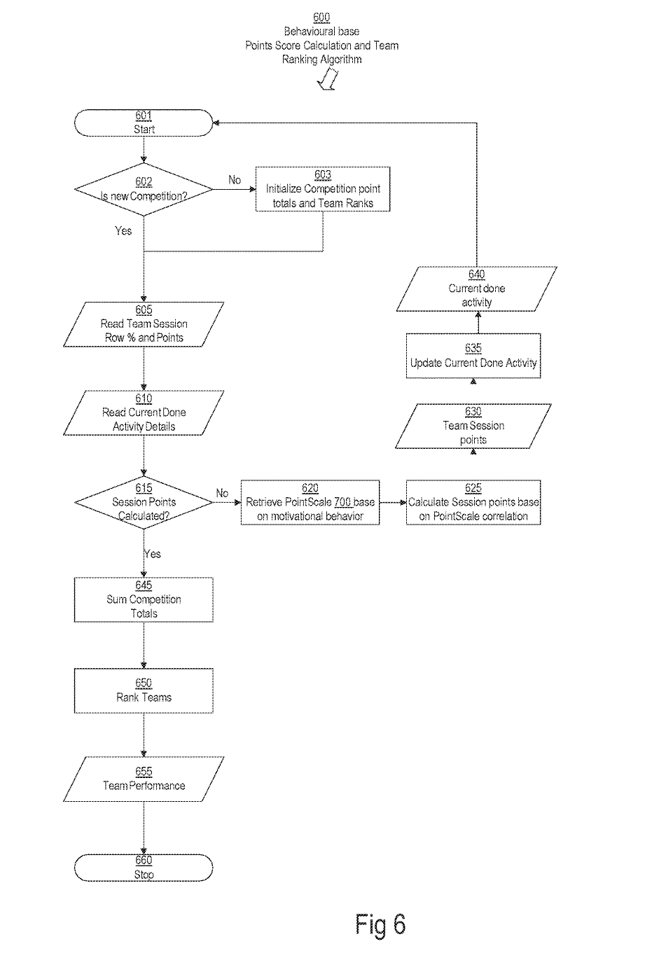

FIG. 6: shows the Behavioral Base Points Score Calculation and Team Ranking Algorithm 600

In block 601 Algorithm starts. Start upon completion of Team Row % calculation after receiving done activity update from Player Device 120 and completion of Activity Normalization Algorithm 500. Block 602 evaluate whether this is a new competition from the configuration data in Engine Database 1205. If new competition, variables initialize for competition points and team ranking in block 603.

In block 605 Algorithm reads Team Session Row % and Team points scores from Engine Database 1205. In block 610 Algorithm reads current done activity details, which includes whether session points calculated or not.

Algorithm has to calculate session numbers before Algorithm calculates competition numbers. Block 615 is a conditional block, which evaluate whether session calculation had done or not for the current done activity. If session points are not calculated, block 620 path is taken.

In block 620 retrieve Point Scales for Different Motivational Behaviors 700 from Engine Database 1205 base on motivational behavior configured for the competition.

Algorithm next execute block 625. Calculate Team Session point's base on Point Scale correlation to the Team Row %. Point Scales for Different Motivational Behaviors 700 graphs shows for each Row %, what would be the points for the team.

Next in block 630 Algorithm stores session points in Engine Database 1205.

Next Algorithm execute block 635. Algorithm needs indication that session points being calculated for the current done activity, which is performed in block 635. In block 640 shows current done activity session calculation status being updated in Engine Database 1205.

Algorithm goes back to start 601 and goes all the way to 615 block as explained above. Now it takes the yes path for the conditional statement in block 615.

Algorithm goes to block 645, if session points calculated for the current done activity. In block 645 sum all the competition season point totals to derive the competition point total. Next in block 650, Rank teams based on the competition point totals.

After calculating team points scores and rank, in block 655, team performance is updated in Engine Database 1205 and Algorithm ends with block 660.

How Motivational Gamification Engine use alternate point scales

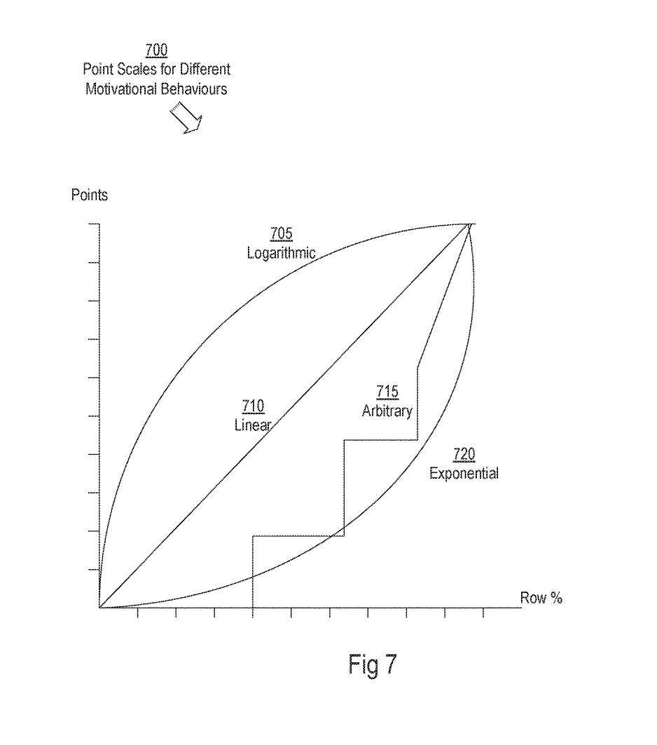

FIG. 7: Motivational Gamification Engine points scale score graphs shows different type of point scale graphs that Motivational Gamification Engine Server 1200 could use to score teams.

Point Scales for Different Motivational Behaviors 700 shows Linear scale 710, Exponential scale 720, Logarithmic scale 705, Arbitrary scale 715 and the like.

It is desirable to have different types of points scale score graphs for different types of organizations to have different type of motivational effects to players and teams.

When it comes to children it may be desirable to de-emphasize the differences among different performing families to make it appear that everyone is almost close. With just a little bit more effort families could put, then not so hard and not so scary to try and beat other families when there is a competition next time. Logarithm scale 705 could be used in family scenario. By adjusting and optimizing Logarithm scale 705 could make families feel like all of them are winners. Similarly, for schools we do not want to emphasize too much differences among student.

On the other hand, for business require high performance. For example, there could be some organizations having all teams are high performing and organization want to emphasize the difference between highest performing and second highest performing teams to give an exaggerated sense of accomplishment. For such scenario Exponential scale 720 could be used to show whoever is little bit better than everyone appears that they are lot better to promote highly competitive environment. Exponential scale 720 is desirable for organizations such as company, corporations and the like to motivate employees and teams.

There could be other type of organizations with teams desiring Linear scale 710 or Arbitrary scale 715 type of motivational effects.

Motivational Gamification Engine Applying to Family

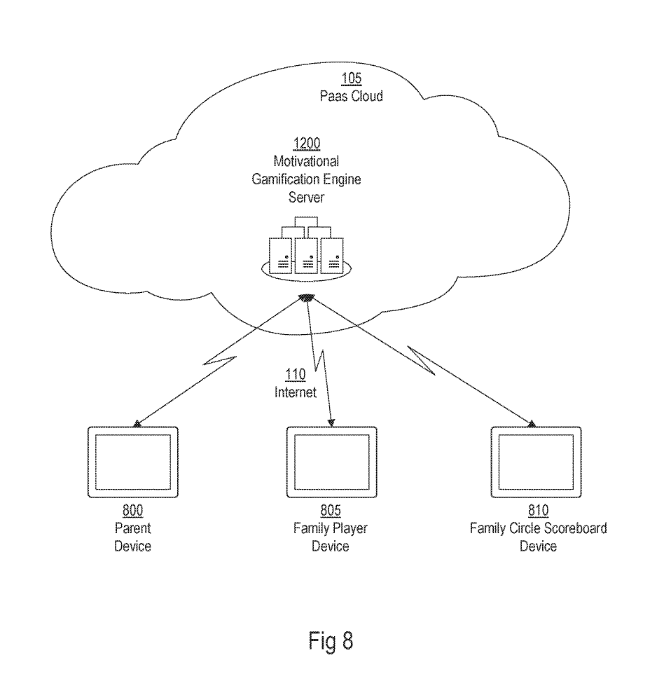

When we take Family example; FIG. 8: Motivational Gamification Engine Network Diagram shows how devices applying to Family. Admin Device 115 is applied to Parent Device 800 where parent, grandparent and the like are the administrator. Player Device 120 is applied to Family Player Device 805, which is used by children or parent players and the like. Team Scoreboard Device 125 is applied to Family Circle Scoreboard Device 810 which is used by whole family for fun and interactive device to see the score of the race competition, position in the race competition compared to other families in the family circle and to see each player in the family how well they are doing to encourage and support each other to win the race competition while completing responsibilities in the family.

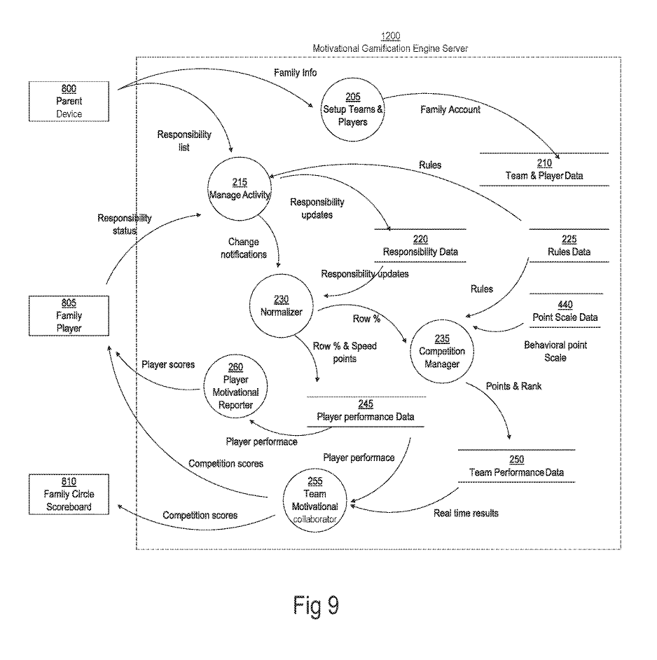

FIG. 9: Motivational Gamification Engine Data Flow Diagram Applying to Family shows how data flows from Family devices to Motivational Gamification Engine Server 1200 and how the data processed and presented back to Family Devices.

In this variant activities are responsibilities that are performed by parents and children and the like. Parents could use Parent Device 800 to set up the family account and responsibilities for each player. Both Parents and Children could play as a team against other known families in the family circle. Both Children and Parents to participate in the competition could use family Player Device 805. Whole family to see the progress of the competition and family position in the race competition against other families in the family Circle could use Family Circle Scoreboard Device 810. How well people do in the competition is determined by how well families collaborate to achieve family responsibilities.

In the family variant, competitions could be weekly with daily sessions.

Motivational Gamification Engine Server 1200 also comprise of social component, Team Motivational collaborator 255 supporting interaction amongst teams and team members. In the family example comprise of parent and child, parent-to-parent, child-to-child and other families in the family circle.

Activity Normalization Algorithm 500 together with rules in Motivational Gamification Engine Server 1200 normalize the difference between family size, age and responsibilities to make the competition fair and fun for the whole family. Point Scales for Different Motivational Behaviors 700 has adjustable point scale graphs for families which motivate families by making close competition between families without showing clear winners or losers but giving the impression as everyone winning and encourage by putting little more extra effort they can win in the next competition.

Motivational Gamification Engine Applying to Company

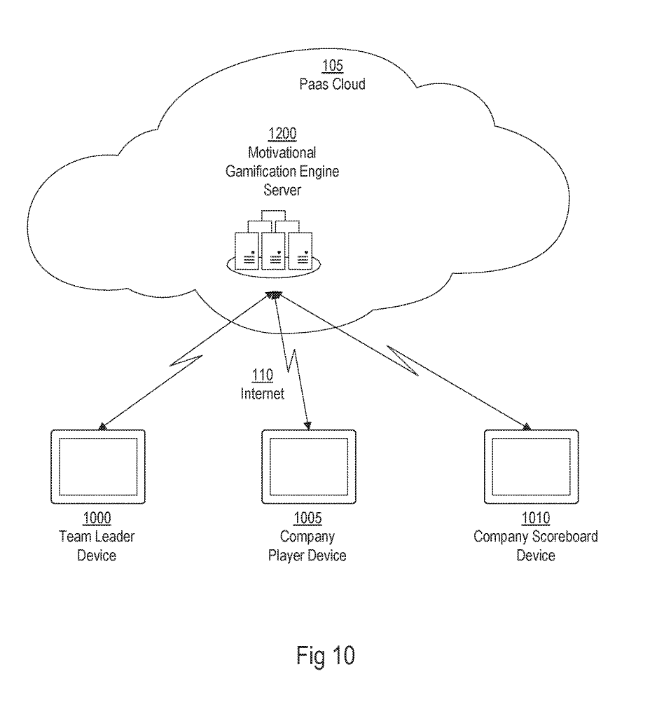

When we take Company as the organization, FIG. 10: Motivational Gamification Engine Network Diagram applying to Company shows how the devices are applied to. Admin Device 115 is applied to Team Leader Device 1000 where team lead and the like is the administrator. Player Device 120 is applied to Company Player Device 1005 which could be used by employees of the company. Team Scoreboard Device 1010 could be applied to Company Scoreboard Device 1010.

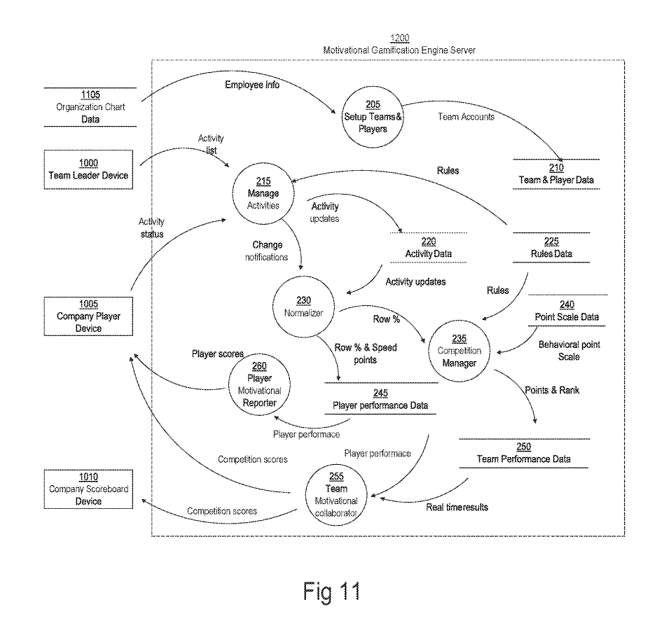

FIG. 11: Motivational Gamification Engine Data Flow Diagram Applying to Company shows how data flows from company Game Engine Client Devices (1000,1005,1010 and the like) to Motivational Gamification Engine Server 1200 and how the data processed and presented back to company Game Engine Client Devices. In these variant activities are job responsibilities and the like. Team lead or scrum master in agile environment and the like can use Team Leader Device 1000 to set up job responsibilities. Organization Chart Data 1105 could be used to set up the teams.

Employees to participate in the competition could use company Player Device 1005.

Whole company teams to see the competition results could use company Scoreboard Device 1010. How well people do in the competition is determined by how well employees in teams collaborate to achieve job responsibilities.

Competitions could be monthly and sessions could be weekly and the like.

Activity Normalization Algorithm 500 together with rules in Motivational Gamification Engine Server 1200 normalize the difference between team size, experience and job responsibilities to make the competition fair and fun for the whole company.

Point Scales for Different Motivational Behaviors 700 has adjustable point scale graphs for teams. In this scenario company could use Exponential 720 point scale graph for example to emphasize high performance behavior among teams.

As you can see from description above Motivational Gamification Engine allow us to create a system where we can create varied motivational scoring system for competitive game with real life activities where we can normalize activities and adjust scoring point scale graphs for different motivational behaviors which could be applied to any organization where there are individuals and groups. Motivational Gamification Engine transforms real life activities to a competitive game making the real life activities fun and interactive motivating people.

Sample data from various embodiments is included by way of example in attached appendices A-E. An illustrative overview is provided in the attached Illustrated Storyboard.

Although specific embodiments have been illustrated and described herein, a variety of alternate and/or equivalent implementations may be substituted for the specific embodiments shown and described without departing from the scope of the present disclosure. This application is intended to cover any adaptations or variations of the embodiments discussed herein.

1. A motivational gamification engine system and method, as shown and described.
